(19) United States
(12) Patent Application Publication
(10) Pub. No.: US 2008/0061732 A1
(43) Pub. Date: Mar. 13, 2008

(54) Communication Device Charged with Solar Energy

(76) Inventors: Kuo-Len Lin, Wugu Township (TW); Tien-Chih Tseng, Wugu Township (TW); Wen-Jung Liu, Wugu Township (TW); Hai--Rui Ye, Wugu Township (TW)

Correspondence Address: HDSL, 4331 STEVENS BATTLE LANE, FAIRFAX, VA, 22033, US

(21) Appl. No.: 11/530,112

(22) Filed: Sep. 8, 2006

(51) Int. Cl. H02J 7/00

(52) U.S. Cl. 320/101

(57) ABSTRACT

A communication device charged by solar energy forms a foldable mobile phone by pivotably connecting a first pivot provided on one end of a host to a display. One end face of the display is provided with a second pivot. A solar plate is pivotably connected to the second pivot of the display to foldably cover on the display. With the above structure, if the electricity of the battery of the mobile phone is insufficient, the user can unfold the solar plate from the display to charge the electrically-connected battery of the mobile phone, thereby to overcome the inconvenience in supplementing the electricity of the battery.

### BACKGROUND OF THE INVENTION

1. Field of the Invention

The present invention relates to a communication device charged with solar energy, and in particular to a foldable mobile phone having two pivots pivotably connected to a solar plate, a display and a host, whereby it is convenient to charge a battery therein by unfolding the solar plate.

2. Description of Prior Art

All currently-used communication devices, such as mobile phone or personal digital assistance (PDA) having a function of communicating, are powered by a battery. However, the amount of electricity accumulated in the battery has a predetermined value. In other words, the standby time or talk time offered by the communication device is also restricted by the amount of electricity accumulated in the battery. Therefore, when the electricity accumulated in the battery of the mobile phone is insufficient, usually, the battery cannot be timely charged with a common socket, automobile cigar-light plug or USB because it is inconvenient for a user to carry a charger or electric line for the battery. Therefore, the user needs to carry a second or even a third spare battery, thereby to replace the exhausted battery to maintain the communication device in a normal state. However, it is inconvenient to carry or replace the spare battery.

As disclosed in Taiwan Patent Publication No.M285126 entitled “Charger For Solar Mobile Phone”, a solar plate is provided to convert solar energy into electricity for providing the necessary electricity of illuminator, charger for mobile phone, mosquito expeller, warning device and field camp lamp. With the above structure, the battery can be charged by electrically connecting to an electric line and the mobile phone.

Further, as disclosed in Taiwan Patent Publication No.448600 entitled “Method For Charging Battery Of Mobile Phone With Solar Energy And Device Thereof”, a solar charging device is coupled to the mobile phone and the battery thereof, so that the charging device can serve as a power supply for the mobile phone and the battery can be charged with the surplus electricity.

The above patent applications all use solar energy as the main energy to be converted into electricity, thereby to charge the battery of the mobile phone for subsequent use. However, each of the above structures for charging with solar energy is to additionally provide a charger. In other words, the function of charging with solar energy is to be incorporated with the charger rather than the communication device. The user still needs to further carry the charger and its electric line for charging with solar energy, which causes inconvenience in use.

In view of the above, the inventor proposes the present invention to overcome the above problems based on his expert experiences and deliberate researches.

### SUMMARY OF THE INVENTION

The present invention is to solve the above drawbacks. According to the present invention, a solar plate is pivotably connected to and foldably covers on a surface of a display via a simple structure. With the above structure, the solar plate can be unfolded at any time to charge the battery disposed in the mobile phone. Therefore, the present invention is a practical communication device that has improvement in supplying the electricity of the battery, the carrying of the spare battery and the mobility of charge.

The present invention provides a communication device charged by solar energy, which comprises a host provided at one end thereof with a first pivot; a display having a first pivotal shaft pivotably connected with the first pivot of the host and a second pivot provided on one end face thereof, and a solar plate provided at one end thereof with a second pivotal shaft pivotably connected to the second pivotal shaft of the display, so that the solar plate can foldably cover on one surface of the display to be unfolded in synchronism with the display or the solar plate can be singly unfolded to charge the battery of the mobile phone.

### BRIEF DESCRIPTION OF THE DRAWINGS

FIG. 1 is a perspective view showing the folded external appearance of an embodiment of the present invention;

FIG. 2 is a side view showing the unfolded state of an embodiment of the present invention;

FIG. 3 is a schematic view showing the unfolded state of an embodiment of the present invention;

FIG. 4 is a side view showing the unfolded state of an embodiment of the present invention;

FIG. 5 is a perspective view showing the unfolded external appearance of an embodiment of the present invention;

FIG. 6 is a perspective view showing the folded external appearance of another embodiment of the present invention; and

FIG. 7 is a perspective view showing the unfolded external appearance of another embodiment of the present invention.

### DETAILED DESCRIPTION OF THE INVENTION

In order to make the Examiner to better understand the characteristics and the technical contents of the present invention, a description relating thereto will be made with reference to the accompanying drawings. However, it should be understood that the drawings are illustrative but not used to limit the scope of the present invention.

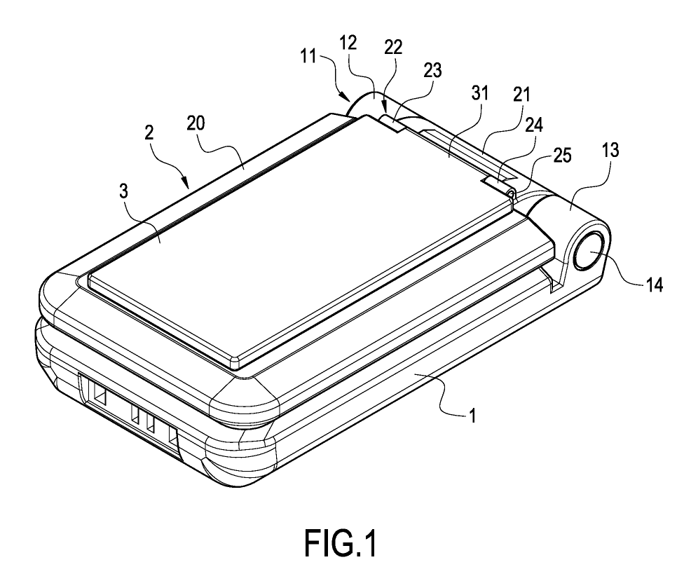

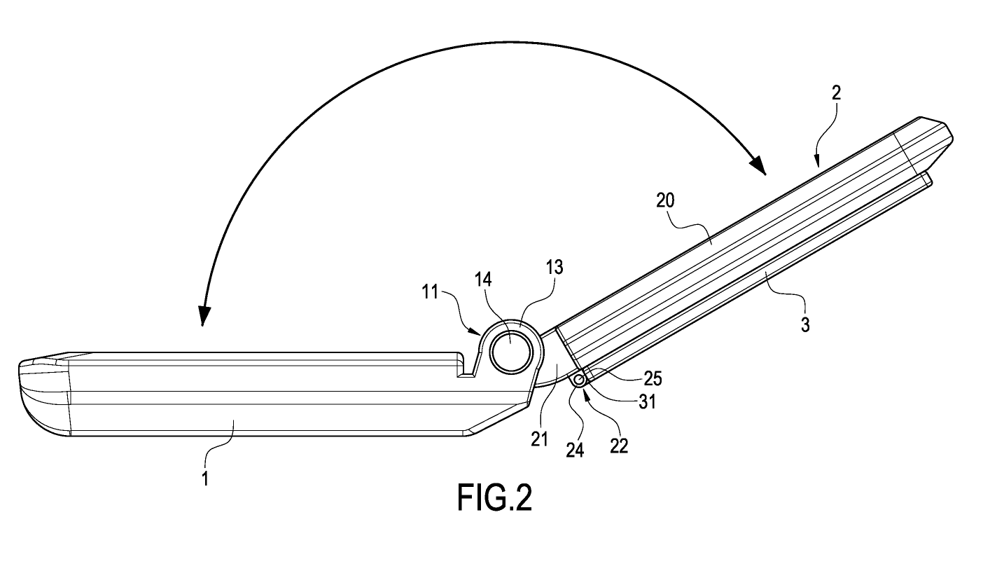

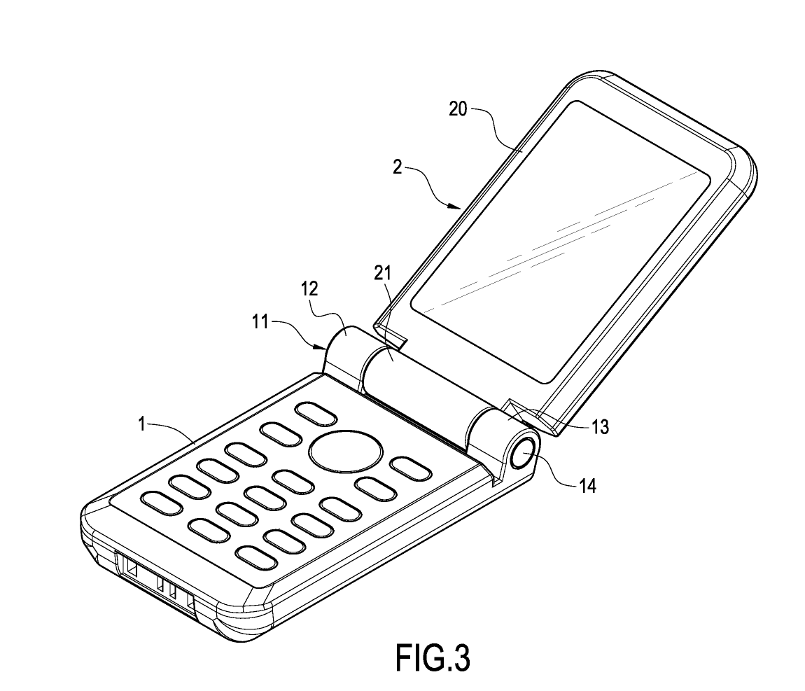

FIGS. 1 to 3 show the communication device charged with solar energy in accordance with the present invention. More specifically, FIG. 1 is a perspective view showing the folded external appearance thereof, FIG. 2 is a side view thereof in which the display is unfolded, and FIG. 3 is a perspective view thereof in which the display is unfolded. As shown in the figures, the communication device charged with solar energy in accordance with the present invention comprises a host 1, a display 2 and a solar plate 3 connected together via two pivots, thereby to form a foldable mobile phone. The host 1 is provided therein with a control circuit and a battery (not shown) for the mobile phone. One end of the host 1 is provided with a first pivot 11 constituted of two pivotal ears 12, 13 and a pivoting means 14 penetrating between the two pivoting ears 12, 13. The pivoting means is conventional and thus the description thereof is omitted. The display 2 is pivotably connected to the first pivot 11. The solar plate 3 is pivotably connected to and folded on one surface of the display 2, thereby to be unfolded in synchronism with the display in communication. As shown in FIGS. 2 and 3, the solar plate may be singly unfolded to charge the battery of the mobile phone. With the above structure, the communication device having the solar plate can be formed, and thus it is convenient to charge the battery of the mobile phone at any time by using the solar plate 3.

The display 2 is provided on a shell cover 20 to correspond to one surface of the host 1. A distal end of the shell cover 20 is provided with a first pivotal shaft 21 to be pivotably connected to the first pivot 11 and the pivoting means 14, so that the display can be folded on the host 1. Further, the other end face of the shell cover 20 is also provided with a second pivot 22 thereon. The second pivot is also constituted of two pivoting ears 23, 24 and a rotating shaft 25.

The solar plate 3 is provided at one distal end thereof with a second pivoting shaft 31 to be pivotably connected to the second pivot 22. In other words, the second pivoting shaft 31 is disposed between the two pivotal ears 23 and 24. With the pivoting connection of the rotating shaft 25, the solar plate 3 is pivotably connected to and foldably covers on the display 2 and one surface of the shell cover 20. Alternatively, the solar plate can be singly unfolded to carry out the absorption and conversion of solar energy into electricity. Further, the solar plate 3 can output the electricity to charge the battery of the mobile phone via the control circuit electrically connected to the host 1 and the battery of the mobile phone.

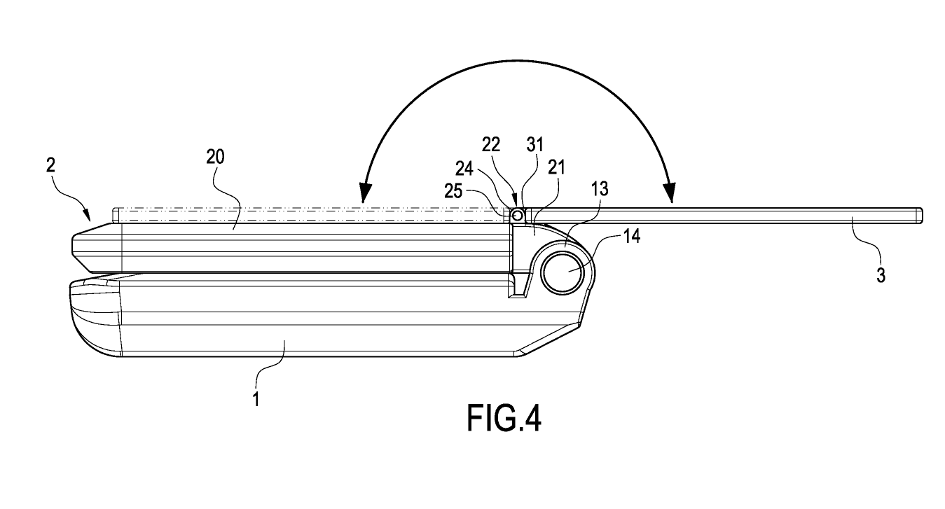

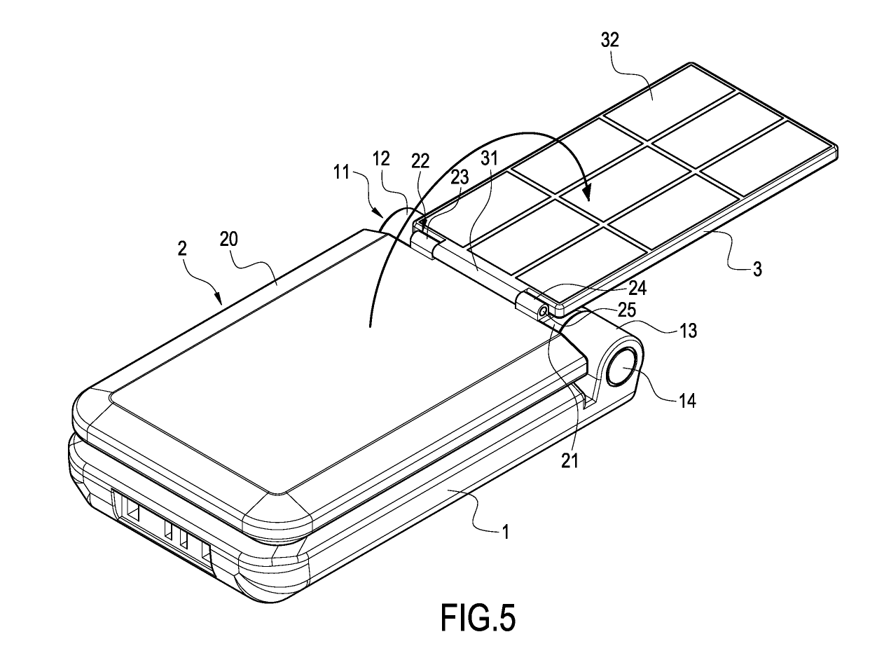

With reference to FIGS. 4 and 5, they are a side view and a perspective view showing the external appearance of the communication device charged with solar device of the present invention in an unfolded state for being charged with solar energy. As shown in the figures, after the communication device charged with solar device in accordance with the present invention has been completely constructed by the above components, if the amount of electricity accumulated in the battery is insufficient, the user can easily unfold the solar plate 3 from one end face of the display 2 via the pivoting connection between the second pivoting shaft 31 and the second pivot 22. In this way, a plurality of solar chips 32 provided on one surface of the solar plate 3 is used to absorb solar energy and then converts it into electricity. After this, by means of the electrical connection, the battery of the mobile phone can be charged. After the charging is completed, the solar plate 3 is folded and covers on one end face of the display 2, thereby to terminate the charging with solar energy.

Since the above structure uses the first pivot 11 to pivotably connect the host 1 and the display 2 and uses the second pivot 22 to pivotably connect the solar plate 3 to one surface of the display 2, so that the solar plate 3 and the communication device can be combined together and the user can singly unfold the solar plate 3 at any time to charge the battery of the mobile phone. As a result, not only the working time of the communication device is prolonged, but also the problem in carrying the spare battery or the charger for replacement or charging can be solved.

Also, the solar plate 3 can be made into a thinned structure. Therefore, even though the solar plate is folded on the display 2, the total thickness of the mobile phone does not increase too much, and thus it has no influence on carrying the mobile phone.

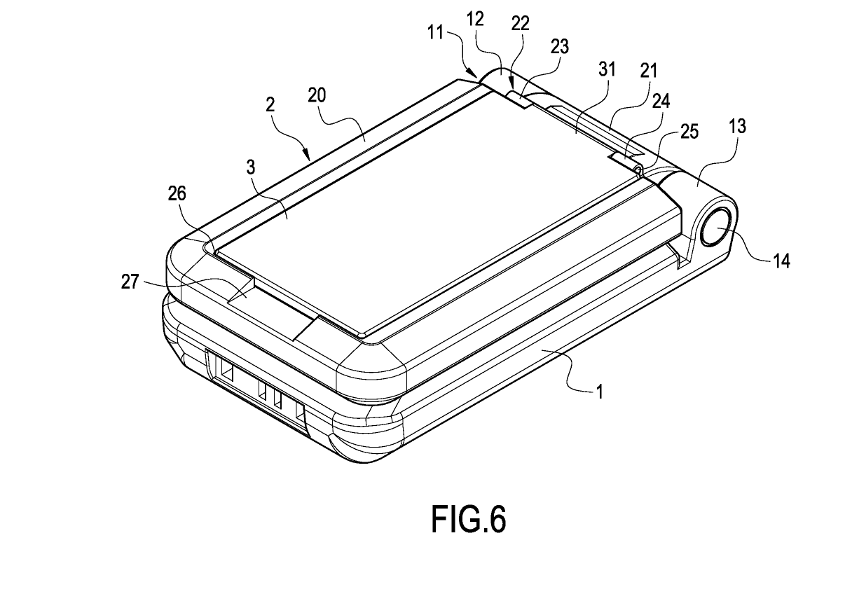

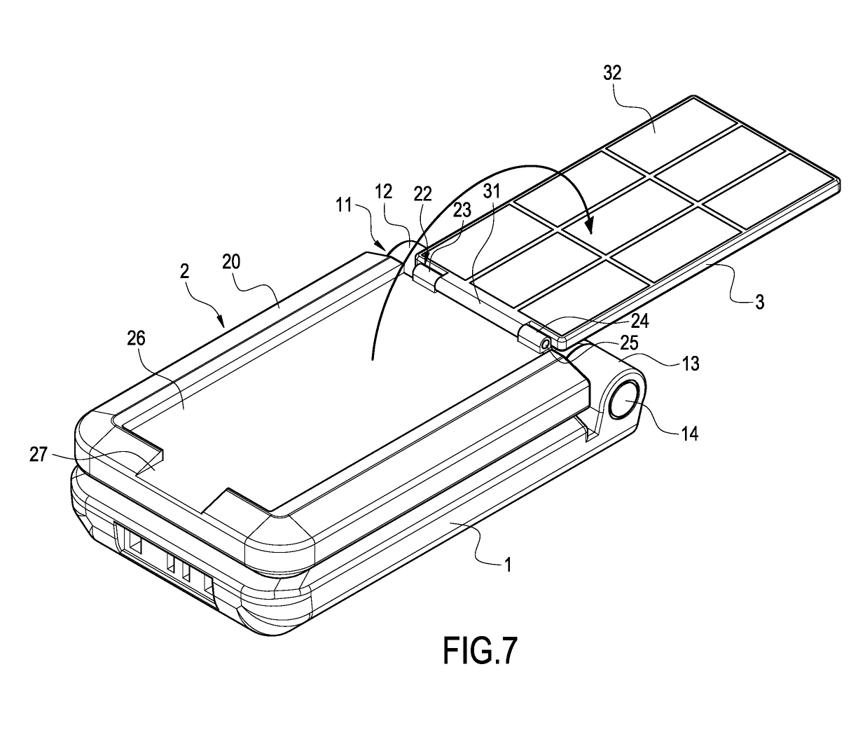

With reference to FIGS. 6 and 7, they respectively show the folded state and unfolded state of the communication device charged with solar energy in accordance with another embodiment of the present invention. As shown in the figures, the present embodiment is substantially identical to that shown in FIGS. 1 to 3. The only difference lies in that the surface of the shell cover 20 of the display 2 on which the solar plate 3 is folded and covers is further provided with a receiving groove 26 for receiving the folded solar plate 3, thereby to facilitate the design in the total thickness of the shell cover 20 and the mobile phone.

Further, preferably, one side of the receiving groove 26 is provided with a notch 27, whereby the user can easily unfold the solar plate 3 from the receiving groove 26 to charge the battery of the mobile phone.

Further, the height of the receiving groove 26 can be designed to be smaller or larger than or identical to the thickness of the solar plate 3 to correspond to the whole thickness of the communication device.

According to the above, the present invention indeed achieves the desired effects and solves the drawbacks of prior art. Further, the present invention involves the novelty and inventive steps and conforms to the requirements for a utility model patent.

Although the present invention has been described with reference to the foregoing preferred embodiments, it will be understood that the invention is not limited to the details thereof Various equivalent variations and modifications can still be occurred to those skilled in this art in view of the teachings of the present invention. Thus, all such variations and equivalent modifications are also embraced within the scope of the invention as defined in the appended claims.

1. A communication device charged by solar energy, comprising:
a mobile phone host provided with a first pivot at one end thereof and a battery therein;
a display pivotably with one end connected with the first pivot and movably folded on one surface of the mobile phone host, one end face of the display, which corresponds to the end of the display connected with the first pivot provided with a second pivot; and
a solar plate pivotably connected with the second pivot of the display, whereby the solar plate is movably folded on one surface of the display to be unfolded in synchronism with the display or the solar plate is singly unfolded to charge the battery.

2. The communication device charged by solar energy according to claim 1, wherein the first pivot of the mobile phone host has two pivoting ears and a pivoting means penetrating between the two pivoting ears.

3. The communication device charged by solar energy according to claim 1, wherein the end of the display connected with the first pivot is provided with a first pivoting shaft to be pivotably connected to the first pivot.

4. The communication device charged by solar energy according to claim 3, wherein the second pivot includes two pivoting ears and a rotating shaft penetrating between the two pivoting ears.

5. The communication device charged by solar energy according to claim 1, wherein the display is provided with a receiving groove on one surface on which the solar plate is folded.

6. The communication device charged by solar energy according to claim 5, wherein the receiving groove is provided at one side thereof with a notch to facilitate to singly unfold the solar plate.

7. The communication device charged by solar energy according to claim 1, wherein one end of the solar plate is provided with a second pivoting shaft to be pivotably connected with the second pivot of the display.
